(19) United States
(12) Patent Application Publication
(10) Pub. No.: US 2003/0061566 A1
(43) Pub. Date: Mar. 27, 2003

(54) Dynamic integration of digital files for transmission over a network and file usage control

(76) Inventors: Laila J. Rubstein, Long Beach, NY (US); Yevgeniy V. Yushin, Long Beach, NY (US); Misha Makarevsky, Jerusalem (IL)

Correspondence Address: Morrison & Foerster LLP, 1650 Tysons Blvd., Suite 300, McLean, VA, 22102, US

(21) Appl. No.: 10/173,511

(22) Filed: Jun. 18, 2002

Related U.S. Application Data
(63) Continuation of application No. 09/191,704, filed on Nov. 13, 1998, now abandoned.
Application No. 09/191,704 is a continuation-in-part of application No. 09/183,626, filed on Oct. 30, 1998, now abandoned.

(51) Int. Cl. G06F 17/60

(52) U.S. Cl. 715/500.1; 705/14

(57) ABSTRACT

The present invention is directed to a process for dynamically integrating two or more digital files (that may be of different types, including but not limited to executable and non-executable files). In one embodiment of the present invention, an advertisement is dynamically integrated with a digital file. More specifically, an animated advertisement file is dynamically integrated with a self-contained executable file for an animated greeting card. In another embodiment, a redeemable gift is dynamically attached to the digital file. In another aspect of the present invention, a control feature is provided to control the usage of the distributed digital file. In one embodiment, a unique code is generated and assigned to the distributed digital file. The unique code prevents the user from, for example, executing the digital file more than a predefined number of times. In a further aspect of the present invention, the control feature may be used for awarding prizes in connection with the distributed digital file.

This application is a continuation-in-part application of U.S. patent application Ser. No. 09/183,626, filed Oct. 30, 1998, which is fully incorporated by reference herein.

### BACKGROUND OF THE INVENTION

1. Field of the Invention

The present invention relates to on-line delivery of electronic files, particularly to dynamically integrating information to construct the electronic files for on-line delivery, and more particularly to dynamically integrating information such as advertisement and/or security codes to application files.

2. Description of Related Art

With the development of the information superhighway, it has become ubiquitous to deliver files from one location to another by electronic means. For example, document files such as electronic mails (often referred to in short as “emails”), text files, video, animation, Virtual Reality, images, audio and the like may be delivered via local area network (“LAN”), wide area network (“WAN”), the Internet, Intranet, and the like wired and wireless networks.

Electronic files transmitted over a network may comprise several components. For example, a Web page, which a user retrieves from a remote server via the Internet, may comprise an HTML (“HyperText Mark-up Language”) file (which is a static description of target document) containing a Java Script or a Java Applet (a small executable file having limited application such as to display a sequence of images). Because the HTML file does not need to be compiled, the Java Script or Java Applet is incorporated in the text file before being transmitted. In essence, the combination of the HTML file and Java Script or Java Applet is an aggregate that does not need to be compiled to link the Java Script or Java Applet to the HTML file. For example, it is very common to find that a Web page includes a display of text and graphics, such as an advertising banner that displays a limited sequence of images driven by a Java Script or Java Applet.

Heretofore, when two or more executable digital files are integrated, they need to be recompiled to properly link the processes of the executable files. (In the context of this document, executable files are files that have been compiled into machine-readable language, such as object code, and can be executed by an operating system directly or by certain, standard or proprietary, interpretation system.) Further, when one of the executable files has been modified, the combination of files has to be recompiled, regardless of the extent of the modification to such one file. Consequently, when small-customized files are to be combined with one of more significantly larger files, the combination files must go through a compilation process, even though the bulk of the files remain unchanged. This causes unnecessary system load, and consequently slowdown in system response.

Accordingly, it is desirable to create a system and process in which executable files may be dynamically integrated on-the-fly without going through compilation of the combined files.

One example of an application of such dynamic integration of executable files is in the context of delivery of executable files over a network, such as the Internet. By way of background, with the availability and growing popularity of the Internet, there is a growing practice of transacting businesses on the Internet. One of the types of businesses that can effectively take advantage of the Internet is the vending of products over the Internet. Instead of calling into the vendor to place an order, a buyer can place an order over the Internet. Further, for certain product such as software implemented products or informational products, the actual product may be retrieved over the Internet for immediate delivery or assessed directly via Internet.

By way of example and not as a limitation, currently electronic greeting cards are available to be purchased over the Internet. The assignee of the present invention, Greeting-cards.com, makes available a wide selection of greeting cards for all occasions, which can be purchased over the Internet. Such greeting cards are each embodied in a self-contained executable file, which executes to display an appropriate animation that delivers the greeting. The purchaser of the greeting card downloads the electronic greeting card executable file, personalizes certain information for the greeting (e.g., the recipient's name, etc.) and then delivers the electronic greeting card directly to the intended recipient as an attachment to an email or by mail (as a stored file on a diskette). The recipient would be able to execute the file and “play” the electronic greeting card.

Typically, the electronic greeting card vendor makes available a number of electronic greeting cards of various designs on a server that can be accessed by customers. Each greeting card design is implemented by a separate executable file. For purposes of marketing and generating additional revenue, it is desirable to attach executable files (such as files for displaying animated logos and/or advertisements) to the executable greeting card files. Further, it is desirable to do so dynamically on-the-fly without having to recompile the existing executable greeting card files.

Further in connection with executable files, it is desirable to provide a security feature that controls the number of times the file may be changed. For example, in the context of personalizable electronic greeting cards, it would be desirable to limit the number of times the file may be reused to personalize different recipients' names, for example.

Still further in connection with executable files, it would be desirable to provide a feature in which certain unique identification may be associated with a particular file for purpose of distinguishing such file from other files that are delivered over a network. For example, in the context of vending electronic greeting card, it would be desirable to assign a unique identification to the greeting card for purposes such as contest, lucky draw, sweepstakes, games and other activities requiring identification control.

### SUMMARY OF THE INVENTION

The present invention is directed to a process for dynamically integrating two or more digital files (that may be of different types, including but not limited to executable and non-executable files). In one embodiment of the present invention, an advertisement is dynamically integrated with a digital file. More specifically, an animated advertisement file is dynamically integrated with a self-contained executable file for an animated greeting card. The animation file for the advertisement may include graphics, video, audio and/or provisions for user interactivity. In another embodiment, a redeemable gift is dynamically attached to the digital file.

In another aspect of the present invention, a control feature is provided to control the usage of the distributed digital file. In one embodiment, a unique code is generated and assigned to the distributed digital file. The unique code prevents the user from, for example, executing the digital file more than a predefined number of times. In a further aspect of the present invention, the control feature may be used for awarding prizes in connection with the distributed digital file.

### BRIEF DESCRIPTION OF THE DRAWINGS

FIG. 1 is a schematic representation of a computer network that can implement the file integration feature of the present invention.

FIG. 2 is a schematic representation of a computer system that deploys the file integration feature of the present invention.

FIG. 3 is a schematic representation of a card file and its content.

FIG. 4 is a schematic representation of the relevant files stored at the server.

FIG. 5 is a schematic representation of the data structure of the last 32-byte location of a card file.

FIG. 6 is a schematic representation of the client and server functions for distributing digital files incorporating unique codes in accordance with one embodiment of the present invention.

FIG. 7 is a schematic representation of the process for user to request prizes from the vendor.

### DESCRIPTION OF THE ILLUSTRATED EMBODIMENTS

The present description is of the best presently contemplated mode of carrying out the invention. This description is made for the purpose of illustrating the general principles of the invention and should not be taken in a limiting sense. The scope of the invention is best determined by reference to the appended claims.

The detailed descriptions that follow are presented largely in reference to examples relating to information handling devices in terms of methods and symbolic representations of operations within information handling devices. These method descriptions and representations are the means used by those skilled in the data processing arts to most effectively convey the substance of their work to others skilled in the art.

A method is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Useful devices for performing the operations of the present invention include, but is not limited to, general or specific purpose digital processing and/or computing devices, which devices may be standalone devices or part of a larger system. The devices may be selectively activated or reconfigured by a program, routine and/or a sequence of instructions and/or logic stored in the devices. In short, use of the methods described and suggested herein is not limited to a particular processing configuration.

Dynamic integration of digital files in accordance with the present invention is desirable for many applications. To facilitate an understanding of the principles and features of the present invention, it is explained herein below with reference to its deployments and implementations in illustrative embodiments. In particular, the invention is described in reference to examples of deployments and implementations in distributed networks, such as computer networks (e.g., Internet, Intranet, WAN, LAN, etc.), communications networks (e.g., wired or wireless networks) and broadcast networks (e.g., WebTV). Other deployments and implementations of the present invention are also discussed to further illustrate the inventive concept. It will be appreciated, however, that these are not the only embodiments in which the invention can be implemented. Rather, it can find utility in a variety of implementations without departing from the scope and spirit of the invention, as will be apparent from an understanding of the principles that underlie the invention.

The dynamic digital file integration aspect of the present invention will be described below in connection with the example of conducting business transactions over a distributed computer network. More specifically, by way of example and not limitation, the present invention is described using the example of vending executable greeting card files over the Internet, and the integration of an executable file relating to an animated advertisement. It is understood that the present invention is applicable to other applications involving digital files.

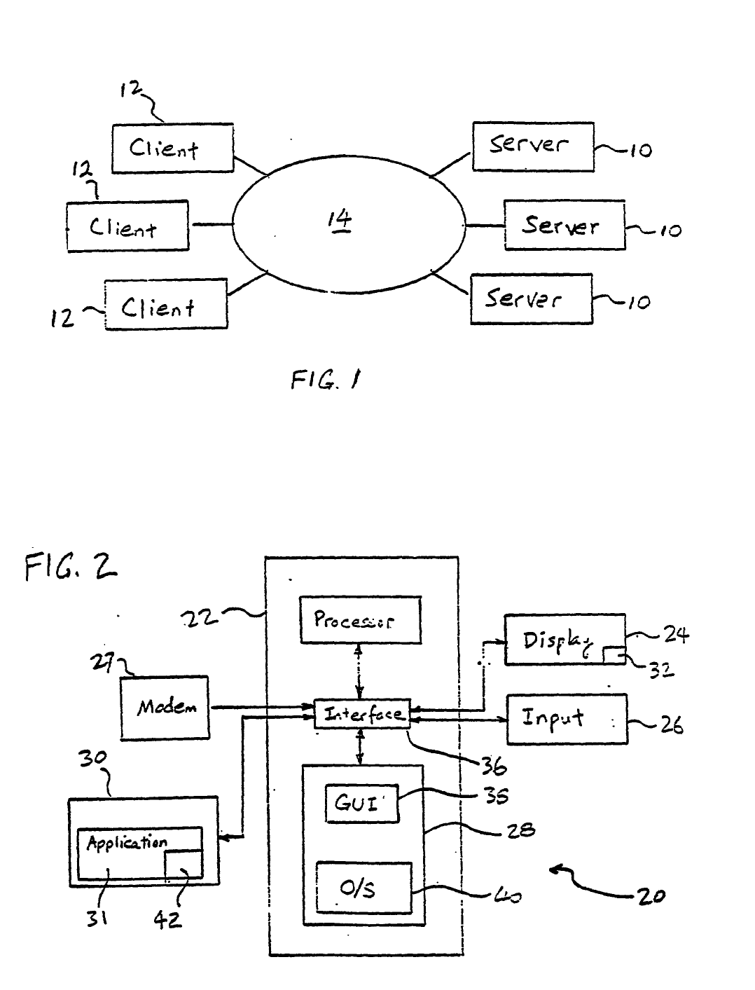

The Internet is an example of a distributed computer network in which the present invention may be implemented, as illustrated schematically in FIG. 1. Many servers 10 are connected to many clients 12 via communication network 14. Details of various hardware and software components comprising the Internet network 14 are not shown (such as servers, routers, gateways, etc.) as they are well known in the art. Further, it is understood that access to the Internet by the server computers and client computers may be via suitable transmission medium, such as coaxial cable, telephone wire, wireless RF links, or the like. Communication between the servers 10 and the client 12 takes place by means of an established protocol.

The structure and arrangement of the devices in which the invention is embodied do not form part of the invention itself. Rather, they are briefly described herein to facilitate an understanding of the manner in which the invention cooperates with various components of such devices. FIG. 2 is a schematic block diagram of a computer system 20 that may function as the client 12 and/or server 14. Typically, the computer system includes a computer 22, a display device 24, an input device 26 such as a keyboard, a network communication device 27 such as a modem, a primary storage device 28 and a secondary storage device 30. The display device 24 displays a graphical user interface (“GUI”) 32 for facilitating the display of graphics and text to the user.

The computer 22 includes one or more processors 34 that fetch computer instructions from the primary storage 28 through an interface 36, such as an input/output subsystem, and executes the instructions. The computer 22 can be, but is not limited to, personal computers, mini-computers and main frame computers, that are running on a number of available operating system and/or machine platforms. The processor 34 can be, but is not limited to, any of the processors available from Intel Corporation, Sun Microsystems, AMD, IBM or any processor capable of executing program instructions including application specific integrated circuits (“ASIC”), field programmable gate arrays (“FGPA”). Executing the computer instructions enables the processor 34 to retrieve data or write data to primary storage 28 and secondary storage 30, display information on the display device 24, receive command signals from the input device 26, or transfer data to other computer systems within the computer network 14. Those skilled in the art understand that the primary storage 28 and secondary storage 30 can include any type of computer storage including, without limitation, FGPA, random access memory (“RAM”), read-only-memory (“ROM”), and storage devices such as hard disks, magnetic media and optical storage media such as CD-ROM.

The primary storage 28 stores a number of items, which may include a GUI 38 (e.g., browser) and a runtime environment 40. The runtime environment 40 typically is an operating system that manages computer resources, such as memory, disk or processor time, required for the application software to run. A number of application software 31, such as word processing programs, spreadsheet worksheet programs, etc., may be installed in the secondary storage 30 in addition to the software 42 that implements the present invention. For example, at the server 10, the application software 42 would include the functionality of dynamically integrating two of more executable files in accordance with the disclosure herein. At the client 12, the integrated executable file that it receives could be stored as an application 31 in storage 30.

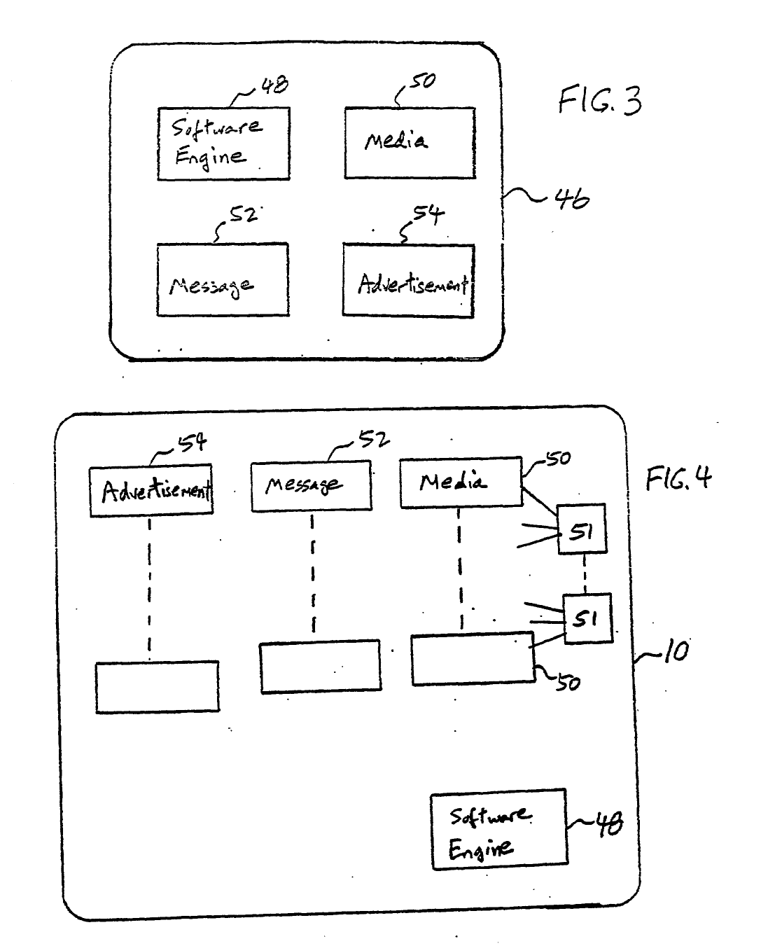

A specific application of the executable file integration aspect of the present invention may be explained in the context of vending greeting card files and animated publicity messages such as advertisement. As mentioned before, greeting card files may be distributed over the Internet in the form of executable files, such as the products distributed by the company Greeting-cards.com. Referring to FIG. 3, the greeting card files 46 are each a self-contained executable file consisting of the following components: a software engine 48 that runs the greeting card (e.g., interactive graphics and/or audio presentations), one or more media content files 50 containing graphics and/or audio data, personalizable message segment file 52 (e.g., “Happy Birthday to ______”, “Happy Valentines Day to ______”, “Merry Christmas to ______”, “Congratulations to ______”,etc.), and an executable file or routine 54 that runs an animated advertisement (e.g., in the form of an animated logo or a animated sequence).

The card file 46 may contain a single digital greeting card, or a number of greeting cards in a set. For example, as will be described in detail below, the card file may be configured to be personalized only once by the purchaser for one recipient. Alternatively, the card file may contain, for example, 5 card designs, each personalizable 10 times for a total of 50 recipients.

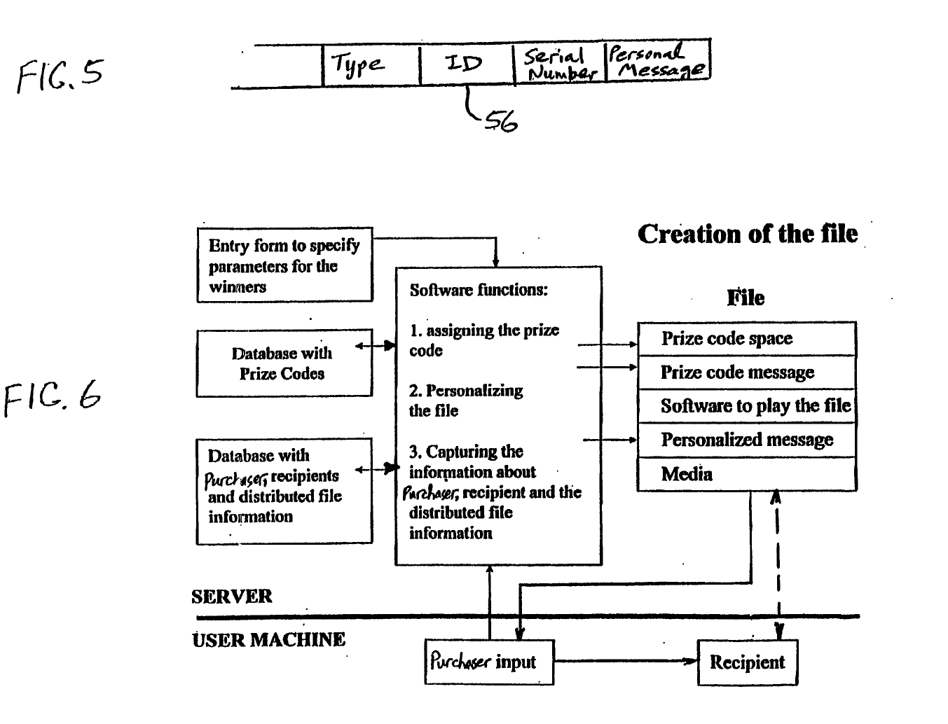

Referring to FIG. 4, in accordance with one embodiment of the present invention, the various components for the self-contained executable file reside on a server 10 as separate files. The components are “assembled” or configured to form the self-contained executable file pursuant to the user requirements, allowing to some extent mixing-and-matching of a design, a media content file and a message. For example, referring to FIG. 4, the card vendor has a collection of 100 different greeting card designs for user selection. Each card design is represented essentially by one or more media content files 50. The media content files 50 may share in common one or more graphics and/or audio data components 51 that make up the card designs. There is a software engine 48 that is useable with the media content files 50 to create the various card designs. There may be additional software engines that are useable to create different cards designs based on the same media content files 50 or additional media content files resident on the server 10. There may be variable number of predefined message segments 52 (e.g., “Happy Birthday to ______”,“Happy Valentines Day to ______”, “Merry Christmas to ______”, “Congratulations to ______”, etc.) that are relevant to the card designs. There may also be a variable number of animated advertisements 54 (which may be in the form of a logo, a banner and other forms of advertisement display); based on the number of advertisers that subscribed to the card vendor. While the example illustrated has all the files residing on a single server, depending on the number and size of the files, the various files or types of files may separately reside on more than one server that are logically coupled, without departing from the scope and spirit of the present invention.

Each advertising logo is an executable routine, which when executed would display an animation comprising graphics, audio and/or provisions for user interactivity to represent a company, a product, a service, a notice, an announcement, and other forms of publicity messages. An advertiser and the card vendor would agree on the placement of the advertisement file at the card vendor's server so that the advertisement could be “attached” to or otherwise integrated into the card file. Typically, the card vendor would charge a fee for such advertising service. The card vendor may create and design the advertisement file in accordance with the advertiser's specifications.

A purchaser of greeting cards may sign on at a client device 12 (e.g., a personal computer, a web enabled television, etc.) to access the card vendor's server via the Internet 14. In the example given above, the purchaser may access the vendor's web site that may or may not be physically located at the vendor's server or maintained or hosted by the vendor. The purchaser clicks on the text or graphics link on a web page and the link/request is established to the server 10. Upon accessing the site (which may include a login sequence), the purchaser may be given a menu of card design options for various categories of occasions. The menu may comprise “hot” or “clickable” buttons or graphic links for user selection of card designs. This type of graphical user interface is well known in the art, and may be part of a browser. Depending on the user's selection of a particular card design, a copy of the corresponding media content file 50 and message segment 52, and the corresponding software engine (in this case there is only one shown) are combined into a card file 46. The purchaser would be requested to enter the relevant information such as purchaser's identification, payment method, etc. Upon verification of the purchaser information, the card file 46 is delivered to the purchaser via HTTP, FTP, or other file transfer protocols or email.

The purchaser can personalize the greeting message in the card after downloading the card file. Personalization may involve providing the name of the recipient of the card, and any addition message that the purchaser would like to convey to the recipient. The software engine 48 included in the card file 46 may be structured and configured to prompt the purchaser for the personalized message. It is noted that alternatively, the system may be configured such that the purchaser may personalize the message at the server end, before the card file is delivered to the purchaser, without departing from the scope and spirit of the present invention. The purchaser delivers the personalized card file 46 to the recipient as an attached file to an email, by a known file transfer protocol, or by mailing a recording medium such as a diskette containing the card file 46. The card file 42, being a self-contained executable file, can be executed by the recipient to play the greetings with graphics and/or audio presentation, over and over again, if she wishes.

In accordance with one aspect of the present invention, an animated advertisement 54 is dynamically integrated into the card file prior to deliver. Based on the requested parameter sent from the purchaser's site, an appropriate advertisements 54 is integrated into the card file so that the resultant image of the advertisement, such as a company logo, is attached to the front of the card, for example. For example, based on the purchaser's profile, a company logo may be dynamically selected from the advertisements 54, then active advertising campaign, etc. The purchaser's profile may be created in a database based on information solicited by the vendor from current purchase or prior purchases or surveys, or from data-mining based on other available databases. For example, an advertisement for a flower store may be attached to a card purchased for Valentine's Day, or an advertisement for a jewelry store may be attached to a card purchased for wedding anniversary. In addition, the purchaser's city zip code may be used to determine the appropriate advertisements for products available for the particular city. For example, the present invention allows the dynamic selection of an advertisement for a chocolate store that is located in or near the city, as opposed to a chocolate store that is not available in or near the city. There could be more than one advertisement 54 attached to the card file, without departing from the scope and spirit of the present invention.

The vendor's server could be configured to track the number of times an advertisement 54 is used so that the vendor could charge the advertiser a fee based on the usage, in addition to any other advertising subscription charges. For example, the advertisement 54 may include an active link to the advertiser's website. The vendor can keep track of the number of users accessing the different cards, the time of such access, and the links invoked by the users, by maintaining a log file that is written in real time into a database at the vendor's server. An extensive report may be created from the log file for marketing purpose or for billing advertisers.

While the card file distribution described above involves the purchaser downloading the card file for customization prior to forwarding it to the recipient. However, it is understood that alternatively, the vendor may provide the purchaser the option of eliminating the download step by allowing the purchaser to customize the card file at the vendor's server. The server provides a post office function as it can send the personalized card file directly to the recipient designated by the purchaser. The card is available for the purchaser to preview before she completes personalizing the card. For additional protection, during personalization process, the text is displayed in a flashing manner and/or with a legend “Preview” to remind the purchaser that the copy of the greeting card is not final. Once the purchaser confirms the final greeting card, the card is sent to the recipient from the server as an attachment to an email. Alternatively, a link to the vendor's server on which the customized card resides is sent to the recipient in an email. The recipient can download a copy of the card by invoking the link in the email message.

The present invention overcomes the deficiencies in the prior art systems. In the prior art, advertisements must be custom generated and included in each file containing the greeting card, for example. Once generated, the advertisement stays with the particular greeting card. Consequently, there is no flexibility for the vendor and advertiser to target advertisements to the appropriate purchaser based on the purchaser's profile. The effectiveness of the advertisement is therefore not reliable for the prior art.

In accordance with the present invention, the advertisements are targeted to the purchasers who are more likely to be interested in the products and services being advertised. The advertisers would receive better returns for the cost of the advertisements. The advertisers can also track the purchasers' responses to particular advertisements by providing active link buttons to their web sites and tracking the number of times their sites are visited through the links from the advertisements. In addition, the present invention also provides the flexibility of integrating new products and new advertisements. As new products (e.g., new card designs) is made available by the vendor, they can be sold with the same advertisements that are already in place without having to custom generate the advertisements with particular new products. As new advertising campaign is made available by an advertiser, it would not be necessary to redo the existing card media files 50.

The concept of integrating advertisements in accordance with the present invention may be advantageously applied to other types of digital files or products, such as in connection with the sale and distribution of textual or graphics files for information services (e.g., web sites) that are not executable files. The advertisement itself need not be an executable file. In addition, digital files and information other than advertisement may be dynamically integrated with another digital file that may represent a certain product or services. The present invention may be implemented in connection with video files, virtual reality files, for example, and other digital files.

Files other than advertisements may be attached to the greeting card to represent a gift to the card recipient. For example, based on the purchaser's selection, a gift certificate or a voucher for a particular product (e.g., chocolate, phone card, etc.) may be attached to the greeting card as a gift (e.g., the voucher is included in the greeting card file 46). At the time the purchaser selects the greeting card design from the vendor's server, she also selects the desired gift to be attached to the greeting card. After the greeting card has been personalized and sent to the recipient, the recipient can download the voucher to redeem the gift from the appropriate source. For example, the recipient may redeem the voucher for a box of candy from a local candy store. In this example, at the time when the purchaser selects the gift, she would be requested to enter the zip code of the recipient so that she will be offered a selection of gifts that are redeemable from the recipient's local store, in addition to other gifts that may be redeemed by mail order. Alternatively, a link may be provided in the greeting card so that gift may be redeemed online from the card vendor or the product vendor.

In another aspect of the present invention, a unique product usage control feature is provided to control the number of times a digital file is used. For example, in the context of the example of the greeting card mentioned above, a control feature is provided to limit the number of times the purchaser can personalize the card file, so that the purchaser would have to repurchase it if she wishes to personalize the same greeting card other recipients exceeding such limit. In accordance with one embodiment of the present invention, the default is that the card file 46 is configured to be limited to one-time use (i.e., customization). The purchaser would not be permitted to initialize the card file with another personal message once she has entered and accepted a prior personalized message.

The control feature is implemented by allocating the last block 56 of 32 bytes of the executable card file for the special needs of the card playing part of the software engine 48 of the executable card file 46. This area is filled during the final stage of the creation of the card file with the basic information, which will allow the player to check components of the card and start the initializing procedures. This block 56 of data also contains the pointer (offset) to the card customization area. The offset may be accompanied by a signature directing to another control structure that is found inside the card file. Preferably, this control structure is located as close to the beginning of the card file as possible so that the downloading process may be verified to determine whether the download has been partially or fully completed.

Referring to FIG. 5, all the unique data of the card such as Type and ID of the card, Serial number and Personal Message text is stored in the last block 56 of 32 bytes in the card customization area. It is filled with default values during creation of the card. Then the Type, ID and Serial Number, Store Code, Creation Date and other parameters are set up by a special program before the card file 46 is delivered to the purchaser. The Type contains data that controls whether personal messages may be allowed to be entered and if duplicated copies of the card file 46 can be used (and how many times it can be reused) and ID represents the coded name of the card. The Type and ID are set up on a Windows based software before uploading to the server. Alternatively, the Type and ID are set up at the server so as to give the vendor better control of the compatibility of the data format. The Serial Number, which is a time-based random generated number, is assigned to the card file by the server software just before the customer can start downloading the card file. Thus, each card file received by the purchaser comes with a unique identification number, which may be a Serial Number in the example given above.

The server will email the URL of the directory location of the card file 46 and the purchaser can return to download the card file 46 again if her attempt to download it earlier did not complete successfully. This eliminates the need and expense for customer service support. In this connection, a unique web page may be created on-the-fly to facilitate customer support for each purchaser or for each card order when the purchaser visits the vendor's site.

The byte size of the various data may be as follows:

| | |
|---|---|
| 1. Offset to main control structure | −4 bytes |
| 2. Signature (63 63 99 99) | −4 bytes (the four-byte sequence is |
| | used to find an exact position of |
| | the control structure in the file) |
| 3. The main control structure has the | |
| following data and byte size | |
| structure: | |
| // Size of the main control structure | −2 bytes |
| // Checksum | −4 bytes |
| // Card ID | −2 bytes |
| // Card Serial Number | −4 bytes |
| // Number of allowed customized | −2 bytes |
| copies | |
| // Customization type | −1 byte (designates download |
| | or online customization) |
| // card sound? | −1 byte (0 or 1, designating |
| | whether sound is used in the card; |
| | some cards are enabled with sound |
| | and some are not; this field may |
| | also be used for indicating whether |
| | video or other types of media |
| | components are used in the |
| | particular card.) |
| // numbers of animation (executable) | −1 byte (3 in a “standard” card) |
| files | |
| // Background color | −1 byte (stage color) |
| // Card name | −10 bytes ascii |
| // Original Customized Type (Free, | −1 byte |
| Demo or Full for sale versions) | |
| // Press Date (when card was created | −4 bytes (year 2000 compliant) |
| (e.g., downloaded and/or | |
| personalized), same as Customization | |
| Date if card is customized on line) | |
| // Customization Date | −4 bytes (year 2000 compliant) |
| // Store Code | −4 bytes |

The status of downloading the card file may be verified by also referring to the last 32 bytes of the card file. In case the download is not complete successfully, the purchaser will see a warning message when she tries to execute the card file (such as “You did not download your card completely. Please email xxxxx@xxxxx.com to request a free, replacement copy.”) Similarly, when the purchaser sends the card file to a recipient, if the recipient did not receive the card file in its entirety, a message is sent from the purchaser's client to the recipient (e.g., “You did not download your card completely. Please ask the person who emailed it to you to send it again.”) Other messages may be included as desired (e.g., reminding the purchaser that a demo is available, or the card file may be distributed for free, etc.)

After the purchaser successfully downloaded the card file 46, and proceeds with personalizing the greeting message, the executable file stores the card ID and Serial Number in a hidden file that is located in the purchaser's system directory. The file acts as a database, which prevents the card file from allowing the purchaser to use duplicates of the original card file (e.g., to personalize the card file with another message). In case if the customer tries to run a duplicate copy of the card file, the duplicate copy will be marked as “already used” so it cannot be used even on another system. In addition or in the alternate, a verification feature is provided to prohibit the purchaser from changing the Serial Number and/or customizing message text once the card has been personalized. Further, checksum may be implemented for virus protection.

The card file may be configured to allow usage of the card file for a limited number of duplicated copies. The Type data in the block 56 of the card file is used to designate the number of times for which the card file may be used. For example, a company may purchase Christmas greeting cards for its customers and staff. The company may order a single card file that may be repeatedly configured for use to produce 1000 personalized Christmas cards. In that case, the company may pay the card vendor for the right to produce the 1000 cards.

In an improved version of the software, the ID field contains additional information about file version (e.g., the type of custom logo, revision, etc.). The Serial Number is built using the function of time, place of creation and a random component (e.g., a random number) in order to guarantee that the same number will not be assigned again. For certain applications as discussed below, this guarantee of uniqueness could be important.

The control feature discussed above may be implemented independent of the dynamic integration aspect of the present invention, and may be extended to many other applications and digital files and information. For example, a unique game code may be assigned to digital files (e.g., greeting cards, or other products represented by the digital files) for purpose of awarding a prize for a lottery, lucky draw, sweepstakes, contest, promotion and other games, which would require some level of security control. In this aspect of the present invention, the process is similar to assigning unique usage control codes to digital files mentioned above.

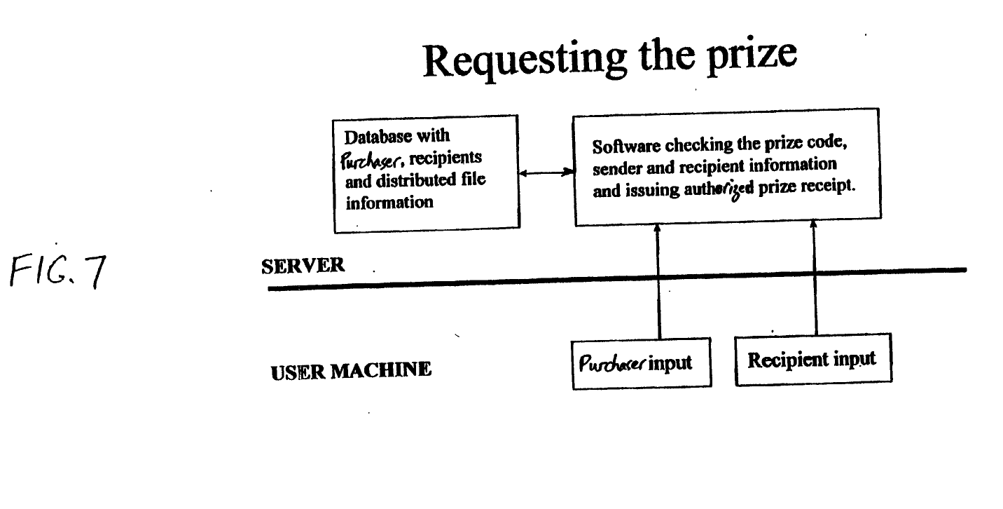

The game code feature will be explained using again on-line distribution of greeting cards in reference to FIG. 6, as an example and not intended as a limitation. The unique game codes may be randomly generated, generated in a specific sequence, or randomly or sequentially taken from a database of codes. It is added to the digital card file 46 much like the usage control code mentioned in the earlier embodiments. The server will fill into the card file (at the last block of the card file) a special data for the game feature. It will include ID of the game, type of the prize and password for online access to the prize. The card file may be created in a manner such that the prize can be split between or doubled for the purchaser of the card file and the intended recipient of the card. The winning prize codes may be predefined as the codes are being assigned (e.g., for those games that identifies instant winners). The winning game codes are selected either randomly or in accordance with a desired logic (e.g., the 1000th customer). (Alternatively, instead of assigning a game code for each card file, only a prize code is assigned for those winning card files. In which case, it can be taken that the game codes “assigned” to the non-winning card files are “null” codes.) Records of game codes assigned may be stored at the server and the winning game codes may be picked at a later date (e.g., for sweepstakes and contests, which may require the user to enter for the game with the assigned game code). For those games that require the user to enter for a contest or sweepstake, for example, a message may be included in the card file referencing entry rules for the game and any entry forms that may be required to be returned to the vendor (e.g., online entry registration by return email or by activating a button on screen to link to the vendor's site). As the server assigns the game code, information about the purchaser and/or the recipient is saved in a special area on the server for future matching of prizes.

In addition, an appropriate message for chosen codes that contain instant prizes is added to the digital files. The message may be structured and configured such that when the user execute or open the file, the message would pop-up. The message may include media content for graphics and/or audio presentations. For example, for a grand prize winning code, the message may be accompanied with fanfare that would say, “You are the winner . . . ”. This message may be personalized based on the personal message entered by the purchaser as she customizes for the recipient of the card, and may include game rules.

After the purchaser has downloaded the card file and executed the card file, if the file is associated with an instant winning game code, the purchaser will see a message about the prize (which may include a short media presentation) and any entry form to be returned. The actual prizes awarded may be sponsored by advertisers. The media presentation may therefore include certain information about the prize and the sponsor. As mentioned before, the card file may be structured such that the purchaser and/or the recipient of the card may be eligible to win. As the purchaser personalizes the greeting card, the software will store the date and time when the card was filled in order to support time-limited events (e.g., a sweepstake for a product promotion campaign).

As in the earlier embodiments, the server may be configured to allow the purchaser to personalize the card file at the server to avoid downloading the card file. In which case, the server will send the personalized card file having the game code directly to the recipient designated by the purchaser.

Referring to FIG. 7, to request the prize, the winner (the purchaser and/or recipient) submits the prize code to the vendor so that the prize code may be verified. This may be done by returning a copy of the executable file containing the winning code back to the vendor so that it can be verified that the game code has not been tempered with. The vendor's server checks the prize code and recipient information and issues an authorized prize receipt, which may be in the form of a voucher, or a prize redemption code for use to redeem prizes from a sponsor, for example. For example, the winning prize may be a telephone calling card that has a prepaid value of $50 worth of calling time. The prize receipt may contain information on the calling card number and activation code thereof so that the winner can start using telephone services without having to call the issuing telephone company for the calling card.

Some of the products and services distributed on-line that can be implemented with the game feature of the present invention may include consumer goods and services, communications, advertising, marketing and promotion agencies, travel services, airlines, etc.

The control feature of the present invention may also be used to provide security to the gifts that are attached to online greeting cards, for example. Using the control feature of the present invention, a unique identification code is assigned to the voucher or gift certificate so that it cannot be duplicated, regenerated or otherwise presented or redeemed more than once by the purchaser and/or recipient of the greeting card. Each card stores a unique identification code and gift voucher number, which is only valid for the particular identification code. Similar to the situation noted before for games and prizes, the identification code and gift voucher number are stored at the vendor's server for later verification if needed, and to ensure that the same identification code and voucher number will not be used again.

For example, the card files including the gift may be structured so that the gift certificate can only be generated once by the recipient. This usage limitation may be provided in a similar fashion as the usage limitation on greeting personalization discussed before. If the recipient has any problem with generating the voucher, she can contact customer service (either online to an automated website or to a live representative) to request a replacement voucher, upon verification of the card identification code and voucher number. The recipient can then apply the voucher to a designated supplier of the gift product (e.g., a store). The supplier will verify with the card vendor (e.g., by contacting online the card vendor's website with the voucher number and/or card identification number or via an automated telephone verification system whereby the supplier would key in the voucher number and card identification code using the telephone touch tone key pad) to authenticate the voucher number and/or the card identification code so as to ensure that the gift has not already been redeemed by the recipient. Instead of having to contact the card vendor for authentication, the supplier may be provided with a list of all eligible voucher numbers from the vendor after the gifts have been purchased by the card purchaser.

If the card is structured to allow online redemption of the gift, the recipient can contact the website link provided or identified in the card, for example. The card identification code and voucher code may be transmitted automatically as the website is contacted. The gift may be downloaded or the recipient may request the gift to be mailed. Alternatively, a password may be issued to the recipient so that she could use the password in conjunction with the voucher number to redeem the gift from a designated supplier. The supplier maintains a list of eligible passwords for verification purposes or contacts the card vendor to verify the password and voucher number.

The present invention has been described above in terms of functional modules in block diagram format. It is understood that unless otherwise stated to the contrary herein, one or more functions may be integrated in a single physical or software module in a software product, or a function may be implemented in separate physical or software modules, without departing from the scope and spirit of the present invention.

It is appreciated that detail discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. For example, the described embodiments referred to digital files that are distributed on-line over a network. It is understood that the digital files may be stored on recording media (e.g., DVD, CD-ROM, magnetic disks, etc.) and distributed by conventional mail or non-electronic sales channels. In addition, the present invention may be implemented for distribution of digital files regardless of whether they were purchased. Accordingly, it is to be understood that the invention is not to be limited by the specific illustrated embodiments, but only by the scope of the appended claims.

1. A method for distributing digital files, comprising the steps of:
providing a first digital file;
providing a second digital file;
dynamically integrating at least the first and second digital files without recompilation.

2. The method of claim 1 wherein at least one of the first and second digital files is an executable file.

3. The method of claim 2 wherein both first and second digital files are executable files.

4. A method for distributing a digital file representing a product or service, comprising the step of dynamically integrating an advertisement file to the digital file without recompilation.

5. The method of claim 4 wherein the digital file is an executable file.

6. The method of claim 5 wherein the advertisement file is also an executable file.

7. A method for controlling usage of a digital file, comprising the step of dynamically assigning a control code to the digital file, wherein the control code includes a designation of the number of times the digital file may be used.

8. The method of claim 7 wherein the control code controls the number of times the digital file may be executed.

9. A method for distributing digital files, comprising the step of assigning a unique game code to each digital file, wherein one or more of the game codes is associated with one or more prizes to be awarded.

10. A method of distributing a digital file, comprising the step of dynamically integrating a file representing a redeemable gift.

11. The method as in claim 10 wherein the redeemable gift is a gift certificate.

12. The method as in claim 10 wherein the redeemable gift is a gift voucher.

13. The method as in claim 10 wherein the digital file represents a greeting card.
